(19) United States
(12) Patent Application Publication
(10) Pub. No.: US 2026/0225781 A1
(43) Pub. Date: Aug. 6, 2026

(54) PACKAGING FILM WITH OXYGEN TRANSMISSION

(71) Applicant: Freshr Sustainable Technologies Inc., Dartmouth (CA)

(72) Inventors: Mina MEKHAIL, Halifax (CA); Francisco Rafael CASTIELLO FLORES, Halifax (CA); Logan Clarence CRAIK, Halifax (CA)

(21) Appl. No.: 19/141,967

(22) PCT Filed: Dec. 21, 2023
(86) PCT No.: PCT/CA2023/051742

§ 371 Date: Jun. 20, 2025

Related U.S. Application Data
(60) Provisional application No. 63/434,890, filed on Dec. 22, 2022.

(51) Int. Cl. B65D 65/42; B65D 65/46; B65D 81/26; B65D 81/28; C08J 7/04; C08J 7/048

(52) U.S. Cl. CPC B65D 65/42; B65D 65/466; B65D 81/263; B65D 81/28; C08J 7/0427; C08J 7/048; B65D 2565/387; B65D 2565/388; C08J 2300/16; C08J 2367/02

(57) ABSTRACT

The present disclosure relates to compostable film, and more particularly to compostable film having desirable oxygen transmission properties for packaging of a perishable item, such as seafood products. According to an aspect, the present disclosure is directed to a compostable packaging film comprising a flexible packaging material defining a plurality of pores and having a barrier coating for regulating the oxygen transmission rate. According to an aspect, the present disclosure is directed to a method of preparing a packaging film, the method comprising: (a) providing a polymer film having an interior food-contact surface and an exterior environment-facing surface opposite the interior surface; (b) modifying the polymer film by micro-perforation, to increase an oxygen transmission rate of the packaging film; and (c) applying a barrier coating to the exterior surface to further adjust the oxygen transmission rate of the packaging film. In an embodiment, the packaging film may be an antimicrobial film.

### FIELD

The present disclosure relates to packaging films, and more particularly to packaging films having oxygen transmission properties.

### BACKGROUND

Packaging films are crucial tools for the transportation of and prolonging the shelf life of perishable items, including food and medicine, by avoiding environmental contamination. Compostable films for packaging are desirable, provided the properties of the compostable films are suitable for a particular use.

### BRIEF DESCRIPTION OF THE DRAWINGS

Embodiments of the present disclosure will now be described, by way of example only, with reference to the attached Figures.

FIG. 1 illustrates a representation of a packaging film according to an embodiment of the present disclosure.

FIG. 2 is the molecular structure of polybutylene adipate terephthalate (PBAT).

FIG. 3 is a flowchart illustrating a method of producing a packaging film according to an embodiment of the present disclosure.

FIG. 4 is a schematic diagram of a method of producing a packaging film according to an embodiment of the present disclosure.

FIG. 5 illustrates a representation of a packaging film according to an embodiment of the present disclosure.

FIG. 6 illustrates a cross-sectional view of a packaging film according to an embodiment of the present disclosure.

FIG. 7 illustrates a cross-sectional view of a packaging film with a bound antimicrobial agent on the food-contact film side according to an embodiment of the present disclosure.

FIG. 8 is a flowchart illustrating a method of producing a packaging film according to an embodiment of the present disclosure.

FIG. 9 is a schematic diagram of the oxygen plasma treatment of a polymer film to create functional groups on the surface of the film.

FIG. 10 shows transmittance percentage over wave number (cm⁻¹) in a PBAT Attenuated Total Reflectance-(ATR) FTIR analysis of samples S1-S7 in Example 1.

FIG. 11 shows transmittance percentage over wave number (cm⁻¹) in a PBAT ATR-FTIR in sample S7 and sample S7b of Example 1.

FIG. 12 shows the antimicrobial effect of functionalized PBAT films against E. coli treated on salmon fish after 24 hours at room temperature.

FIG. 13 shows photographic images of agar plates of different samples after microbiological analysis showing visual differences between controls and plasma treated film system.

FIG. 14 is a schematic of a method of making a PBAT film according to an embodiment of the present invention.

FIG. 15 shows the OTR effect of perforated PBAT film.

FIG. 16 shows the OTR effect of varying barrier coating thicknesses on PBAT film.

FIG. 17 shows the oxygen permeability effect of pore density in a PBAT film.

FIG. 18 shows the oxygen permeability effect of barrier coating on a PBAT film.

FIG. 19 shows vacuum effects of perforation and barrier coating of a PBAT film.

FIG. 20 shows the vacuum effects of perforation and barrier coating of PBAT film.

FIG. 21 shows vacuum effects of perforation and barrier coating of a PBAT film after time has passed.

### DETAILED DESCRIPTION

The present disclosure relates to compostable film, and more particularly to flexible packaging material, such as a compostable film, having desirable oxygen transmission properties for packaging of a perishable item, such as seafood products.

According to an aspect, the present disclosure is directed to a compostable packaging film comprising a flexible packaging material defining a plurality of pores and having a barrier coating for regulating the oxygen transmission rate. The compostable packaging film may comprise a flexible packaging material having an interior food-contact surface and an exterior environment-facing surface opposite the interior surface, the flexible packaging material defining a plurality of pores fluidly connecting the interior surface and the exterior surface; and a barrier coating covering the exterior surface and covering the plurality of pores on the exterior surface.

According to another aspect, the present disclosure is directed to a method of preparing a packaging film, the method comprising: (a) providing a polymer film having an interior food-contact surface and an exterior environment-facing surface opposite the interior surface; (b) modifying the polymer film by micro-perforation, such as by laser, thermal, vacuum or needle micro perforation or other means, to increase an oxygen transmission rate of the packaging film; and (c) applying a barrier coating to the exterior surface to further adjust the oxygen transmission rate of the packaging film. In an embodiment, the packaging film may comprise an antimicrobial film.

According to another aspect, the present disclosure is directed to a method of preparing a packaging film, the method comprising (a) providing a polymer film having an interior food-contact surface and an exterior environment-facing surface opposite the interior surface; (b) modifying the polymer film by micro-perforation, such as by laser micro-perforation, to increase an oxygen transmission rate of the packaging film; (c) applying a barrier coating to the exterior surface to further adjust the oxygen transmission rate of the packaging film; (d) modifying the interior surface by UV, chemical oxidation, plasma or corona treatment; (e) chemically linking an antimicrobial agent to the modified interior surface; (f) modifying the interior surface by UV, chemical oxidation, plasma or corona treatment; and (g) chemically linking an antimicrobial agent to the modified interior surface.

The pores, which may be formed by channels or perforations for example, may permit fluid flow, such as gas flow, across the packaging material at a particular rate. A barrier coating on one surface, covering some or substantially all of the pores on one side of the surface of the packaging material may further regulate the rate of fluid flow as a function of the barrier coating's thickness or composition. Accordingly, the overall rate of fluid flow across the film may be regulated by the pores of the packaging material, including this size and distribution of the pores, as well as the thickness and composition of the barrier coating on a surface of the packaging material.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

### Introduction

Clostridium botulinum(C. botulinum) is a spore-forming bacteria that may release botulinum toxins during its growth [2-4]. These toxins may cause botulism disease in humans, even when ingested in small quantities [2-4]. The United States Food and Drug Administration (FDA) identified this as a major food safety risk, particularly for fresh seafood products, where C. botulinum has been shown to proliferate when packaged under vacuum conditions. Hence, according to FDA guidelines, fresh seafood must be packed and transported in aerobic conditions with a package that possesses a high gas transmission rate (GTR), for example, a high oxygen transmission rate (OTR).

Skin packaging has emerged as one desirable method of packaging perishable items, such as fresh fish, since it may offer a better customer experience. Skin packaging may be similar to vacuum packaging, with the exception that a film may be heated prior to being vacuum sealed on the fresh fish, to make it more aesthetically appealing. Additional benefits of skin packaging over other forms of packaging may include: a reduction in packaging material waste; an increase in the product shelf-life; and a reduction in drip. Hence, to be able to skin pack fish and seafood products safely, the packing film must allow enough oxygen transmission but also hold vacuum.

Compostable films for packaging are desirable, provided the properties of the compostable films are suitable for a particular use. In particular, packaging films having an OTR of a certain level may be desirable. For example, FDA regulations for fresh seafood vacuum/skin packaging require the packaging film to have a ≥10,000 cc/m²/day OTR.

Accordingly, films having a suitable OTR and films that are compostable are desirable, especially with increasing concerns around plastic pollution and increasing demand for sustainable packaging. Compostable films according to one or more embodiments may further include an antimicrobial agent, as herein described.

Compostable Films Having Desirable OTR Embodiments of the present disclosure provide a compostable film and a method of applying film to packaging, wherein the film has desirable oxygen transmission properties. For example, the compostable film may have an oxygen transmission rate greater than 7,000 cc/m² /day, such as about 10,000 cc/m²/day. In other examples, the compostable film may have an oxygen transmission rate of about or less than 7,000 cc/m²/day.

In one aspect, the present disclosure provides a compostable packaging film comprising: a flexible packaging material having an interior food-contact surface and an exterior environment-facing surface opposite the interior surface. The flexible packaging material may define a plurality of pores fluidly connecting the interior surface and the exterior surface; and a barrier coating covering the exterior surface and covering the plurality of pores on the exterior surface.

In one or more embodiments, the packaging film may include an antimicrobial agent chemically linked to the interior surface, such as the antimicrobial agents herein described. The packaging film may include a hydrogel layer disposed on the interior surface, such as the hydrogel layers herein described.

In one or more embodiments, there is provided a packaging film comprising: a polymer film having an interior food-contact surface; and an antimicrobial agent chemically linked to the interior surface. The polymer may be a compostable polymer. The polymer may be a polymer selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof. The polymer may be PBAT.

In one aspect, the present disclosure provides a method of preparing a packaging film, the method comprising: providing a polymer film having a surface; and modifying the surface by laser micro-perforation, to increase the oxygen transmission rate of the packaging film.

In one aspect, there is provided a packaging film prepared according to the method herein described. The packaging film may be compostable, or at least partially compostable.

In one aspect, there is provided a use of the packaging film herein described in packaging for a perishable item. The surface of the film may be configured to be in contact with a surface of the perishable item.

As used herein, “oxygen transmission rate” or OTR is a measure of the transmission of oxygen through a given material. OTR values are in cc/m²/day, or the volume of oxygen (measured in cubic centimeters) per surface area of the material (measured in meters squared) per day. In one example (Example 4) a PBAT film was determined to have an OTR of 700 cc/m²/day. As used herein, an OTR value of less than 1000 cc/m²/day, such as about 700 cc/m²/day may be considered to be “low OTR”. In other examples (e.g. Example 5) compostable films are disclosed with increased OTR, as the surface of the film includes a plurality of pores. As used herein, an OTR value of about 10,000 cc/m²/day may be considered to be “high OTR”.

### Polymer Film

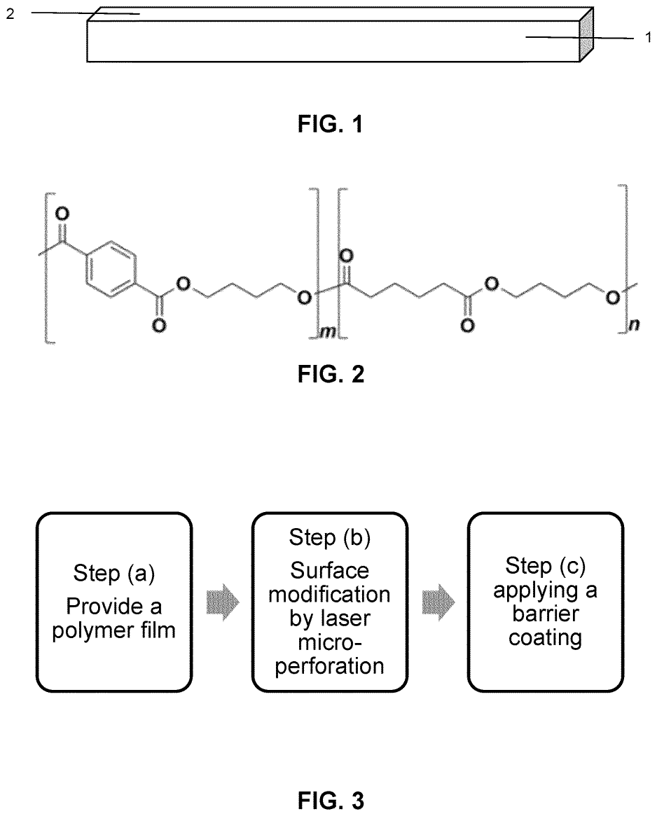

FIG. 1 illustrates a representation of a packaging film according to an embodiment of the present disclosure. The packaging film according to embodiments of the present disclosure comprises a flexible packaging material defining a plurality of pores and having an oxygen transmission rate of about 10,000 cc/m²/day or greater than about 10,000 cc/m²/day. FIG. 1 shows an embodiment of a packaging film (1) having an interior food-contact surface (2), the interior surface (2) defining a plurality of pores (not shown). The plurality of pores may fluidly connect the interior surface to an exterior surface opposite the interior surface of the flexible packaging material (not shown) to permit the flow of gas through the plurality of pores. The plurality of pores may be alternatively referred to as a plurality of perforations or a plurality of channels, for example.

In one or more embodiments, the present disclosure provides a packaging film comprising: a flexible packaging material having an interior food-contact surface and an exterior environment-facing surface opposite the interior surface, the flexible packaging material defining a plurality of pores fluidly connecting the interior surface and the exterior surface; and a barrier coating covering the exterior surface and covering the plurality of pores on the exterior surface. The packaging film may be compostable. The packaging film may comprise a polymer film. The polymer may be compostable.

The pores may be micro-pores. The micro-pores may be from about 1 to about 250 μm in size, such as about 50 μm, about 65 μm, or about 80 μm. The plurality of pores may be of substantially the same size, or they may have varying sizes. The flexible packaging material may define the plurality of pores with low pore density, mediμm pore density, or high pore density. The flexible packaging material may define the plurality of pores with a substantially consistent pore density or with varying pore density. In one or more embodiments, the polymer film has a thickness of about 1 mil to about 5 mils, such as about 2 mils, 2.5 mils, or 3 mils. 1 mil is equivalent to 25 microns. It will be understood that the type of flexible packaging material and its thickness, as well as the size and distribution of the pores may vary, for example to achieve target properties, such as a target OTR.

In one or more embodiments, the packaging film of the present disclosure has an OTR greater than about 7,000 cc/m²/day, such as about 10,000 cc/m²/day. It will be understood that a target OTR may vary depending upon the application. For example, packaging film for seafood products may have a target OTR of 10,000 cc/m²/day.

In one or more embodiments, the method of preparing the packaging film may include forming a polymer into the polymer film, prior to providing the polymer film. Forming the polymer into the polymer film may include extruding a polymer resin into the polymer film by film blowing or film casting. The polymer may be a compostable polymer. The polymer may be selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof. The polymer may be PBAT. The polymer film may have a thickness of about 1 μm to about 500 μm.

In one or more embodiments, the method of preparing the packaging film may include applying a gel coating to the exterior surface to further adjust the oxygen transmission rate of the packaging film.

In one or more embodiments, the method of preparing the packaging film may comprise regulating the oxygen transmission rate of the packaging film by varying a thickness of the applied gel coating.

In one or more embodiments, the gel coating may comprise one or more fillers to further adjust the oxygen transmission rate.

In one or more embodiments, the one or more fillers may be selected from the group consisting of, for example, porous micro-and nanoparticles made of organic and inorganic materials, including but not limited to silicon, amorphous silica, diatomaceous earth, silicon dioxide, aluminum-based, Zeolites, calcium carbonate, kaoilin, alumina trihydrate, calcium sulfate, carbon-based particles, gold, silver, copper, zinc, and their oxides, etc. Biopolymeric particles including but not limited to cellulose-based, chitin, gelatin, chitosan, alginate, polylactic acid, and polyglycolic acid. Synthetic polymeric particles including but not limited to polymethyl methacrylate, polystyrene, polyacrylate, Polytetrafluoroethylene, Poly(vinyl acetate), Poly(vinyl chloride), among others.

In one or more embodiments, the method of preparing the packaging film may further comprise applying a barrier coating to the exterior surface to further adjust the oxygen transmission rate of the packaging film.

In one or more embodiments, the method of preparing the packaging film may further comprise regulating the oxygen transmission rate of the packaging film by varying the thickness of the applied barrier coating.

In one or more embodiments, the method of preparing the packaging film may be applied by a controlled deposition technique. The controlled deposition technique may be selected from the group consisting of: Mayer rod coating, doctor blading, spray deposition, Langmuir-Blodgett film deposition and slot-die coating. The barrier coating may be chemically cross-linked to form a substantially stable hydrogel-like coating.

The polymer film may comprise one or more polymers. The polymer film may comprise a compostable or biodegradable polymer. The polymer film may comprise, for example, PBAT, polylactic acid, a polyhydroxyalkanoate, polybutylene succinate, a cellulose-based material, polyglycolic acid, polycaprolactone, polyvinyl alcohol, a carbohydrate-based material, a protein-based material, or combinations thereof. The polymer film may be a non-biodegradable polymer. The polymer film may be polyethylene, polypropylene, polyvinyl chloride, polyethylene terephthalate, polystyrene, or combinations thereof. The polymer film may comprise PBAT, polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, or combinations thereof.

FIG. 2 shows the chemical structure of PBAT.

The packaging film according to embodiments of the present disclosure may include other components. The packaging film may specifically exclude other components. The packaging film may be substantially free, or completely free of inorganic components. The packaging film may be free of antibiotic drugs. The term “antibiotic drug” as used herein may be used interchangeably with antibiotic small molecules, and encompasses small molecule antibiotic drugs having various mechanisms of action including targeting the cell wall/cell membrane, or interfering with bacterial enzymes. The term “antimicrobial agent” or “antibacterial agent” as used herein includes, for example, IgY, which is a protein that is mainly targeting the surface of the bacteria, and can induce its antibacterial effect via structural alteration of the bacterial surface [8]. The term “substantially free”, as used herein, means about 30 wt. % or less. The term “completely free”, as used herein, means about 1 wt. % or less.

The packaging film according to embodiments of the present disclosure may be used in any suitable packaging product, such as films, trays, or solid backing.

FIG. 3 is a flowchart illustrating a method of producing a packaging film according to an embodiment of the present disclosure. In an embodiment, the method includes the steps of (a) providing a polymer film having an interior food-contact surface and an exterior environment-facing surface opposite the interior surface; (b) modifying the polymer film by micro-perforation, such as by laser micro-perforation or other means of micro-perforation, to increase an oxygen transmission rate of the packaging film; and (c) applying a barrier coating to the exterior surface to further adjust the oxygen transmission rate of the packaging film. The method may include forming a polymer into the polymer film, prior to step (a). The polymer may be a compostable polymer.

In one or more embodiments, the method of preparing the packaging film may additionally include: modifying the surface by UV, chemical oxidation plasma or corona treatment; and chemically linking an antimicrobial agent to the modified interior surface. Chemically linking the antimicrobial agent to the modified interior surface may include chemically linking a hydrogel layer to the modified interior surface. Modifying the interior surface by UV, chemical oxidation, plasma or corona treatment and chemically linking the antimicrobial agent to the modified interior surface may be carried out as herein described to achieve a packaging film comprising: a polymer film having a surface, the surface defining a plurality of pores; and an antimicrobial agent chemically linked to the surface.

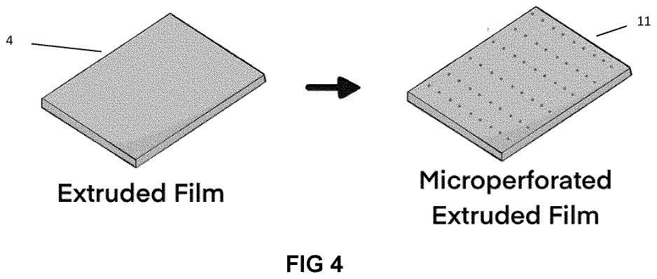

FIG. 4 is a schematic diagram of a method of producing a microperforated packaging film (11) from an extruded film (4) according to an embodiment of the present disclosure. In FIG. 4, the pore size on the microperforated extruded film 11 is exaggerated to assist in illustration. Micro-perforation may be made by known means including laser, needle, or other means.

### OTR Adjustment

OTR may be adjusted in one or more ways including by selecting a desirable micro-pore size, micro-pore density, providing a coating layer, barrier coating thickness, barrier coating composition and/or other means.

The packaging film as described herein may be used for any suitable purpose. The packaging film having a desirable OTR may be used in packaging for a particular perishable item or items or an associated device. The perishable item may be food, chemicals, pharmaceuticals, plants, and animal products. The perishable item may be a food item. The food item may be meat, poultry, pork, fruits, vegetables, or seafood. The food item may be fish, such as salmon, branzino, tilapia, halibut, cod, sole, perch, walleye, catfish, tuna, yellowtail, kampachi, snapper, swordfish, grouper, trout, bluefish, mackerel, sardines, anchovies, or herring. The food item may be a whole fish, or a fish portion such as a fish fillet.

The packaging may be entirely composed of the packaging film, or the packaging film may be only one component of the packaging. The interior surface of the film may be configured to be in contact with a surface of the perishable item. The hydrogel layer of the film may be configured to be in contact with a surface of the perishable item. The antimicrobial agent may remain substantially bound to the film and may not diffuse into the perishable food item. The packaging may inhibit microbial growth on the perishable item. The packaging may inhibit bacterial growth on the perishable item. The packaging may inhibit bacterial growth on the perishable item up to 10,000-fold (i.e. 4-log) relative to a control of PBAT film with no antimicrobial surface. The packaging, or a portion of the packaging, may be compostable or biodegradable.

The packaging may also be used in a medical application, such as wound care. The packaging may be used in cannabis-related packaging, such as the packaging of cannabis plants or products. This packaging may be used in other applications, for example, meal kits, filtration membranes, water treatment, and textiles.

### Micro-Pore Size and/or Density

To achieve a desired OTR of the packaging material, rolls of PBAT may be prepared by melting commercially available PBAT resin and passing it through a blown-film extrusion machine to a final thickness of about 10 μm to about 500 μm. Micro-pores may be created by known techniques in the field such as laser, needles methods such as but not limited to hot pin perforating, cold pin perforating, slit perforating, tear line perforating, punch perforating, rotary punch perforating, thermal perforating, vacuum perforating, embossing, and other techniques. The perforations may be within a range of about 60 μm to about 100 μm where the pore density may vary from about 100 to about 10,000 perforations/m².

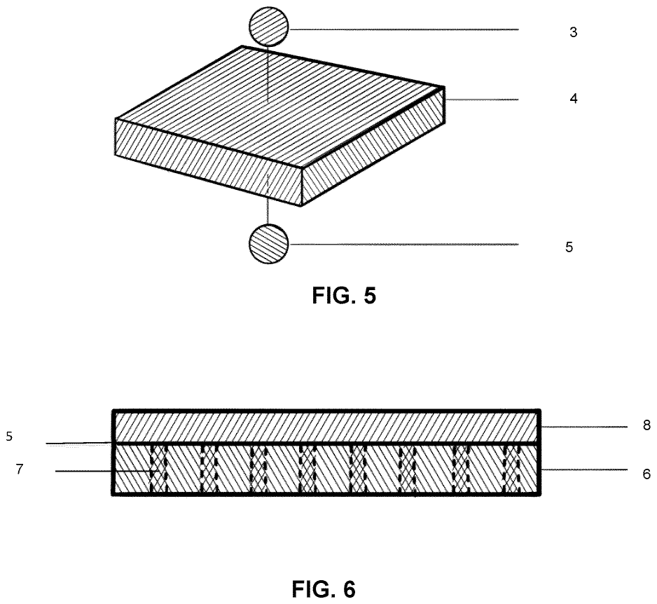

FIG. 5 illustrates a representation of a packaging film according to an embodiment of the present disclosure. A film (4) may comprise an interior food contact surface (3) and an exterior environment-facing surface (5).

FIG. 6 illustrates a cross-sectional view of a packaging film according to an embodiment of the present disclosure. The embodiment of FIG. 6 shows a packaging film (6). The exterior of the film may be coated with barrier coating (8). The packaging film (6) may be a compostable and micro-perforated packaging film.

Polymer film (6) may be modified by laser micro-perforation or other micro-perforation means, to produce a plurality of pores (7) to increase the oxygen transmission rate of the packaging film. A barrier coating (8) may be applied to the exterior surface (5) of the polymer film (6) to further adjust the oxygen transmission rate of the packaging film. The thickness or the composition of the barrier coating may be selected to regulate the OTR through the packaging film. The polymer film (6) may be additionally treated by corona treatment, plasma treatment or chemical oxidation for creating a more reactive exterior surface (5) prior to the application of the barrier coating (8).

### Coating Layer and/or Barrier Coating

Functional chemical groups for covalent bonding of a coating layer used to further adjust the OTR of the film may be created on the surface of the PBAT film via corona-treatment within a power range between about 0.2 KW to about 1.6 KW for approximately 1-30 seconds in ambient air. Functional groups formed on the surface of the PBAT film after corona treatment may include but are not limited to carboxyl groups, ketones, alcohols, aldehydes, and epoxides.

After corona treatment, a barrier coating may be prepared using an aqueous mixture of carboxy methyl cellulose (CMC) sodium salt 1-10% (w/v), of mediμm viscosity and dried fish gelatin between about 1% w/v and about 20% w/v and a filler such as diatomaceous earth between about 1% (w/v) and about 20% (w/v). Then, the CMC/gelatin coating may be chemically crosslinked using an aqueous solution containing about 1 -10 mg/mL to about 50 mg/mL 1-(3-Dimethylaminopropyl)-3-ethylcarbodiimide hydrochloride (EDC) and about 1 mg/mL to about 50 mg/mL of N-Hydroxysuccinimide (NHS). The activated solution may be poured onto the corona-treated PBAT film and spread using known techniques in the coating field such as Mayer rod, graveur, doctor knife, or other means to create a homogeneous coating with a thickness between about 5 μm to about 50 μm. The coated film may be allowed to dry fully by ambient air or any other force air drying technique such as air knives or a convection oven or other means.

In one or more embodiments, the packaging film may include a barrier coating on the external surface to further control or regulate the GTR through the packaging film. The barrier may cover all or substantially all the pores on the external surface. The barrier coating may comprise at least one biopolymer. The barrier coating may cover substantially all the pores. The barrier coating may comprise at least one biopolymer, which may be cross-linked to form a substantially stable hydrogel-like coating. The barrier coating may have a particular thickness or composition to regulate the GTR of the packaging film depending upon the application.

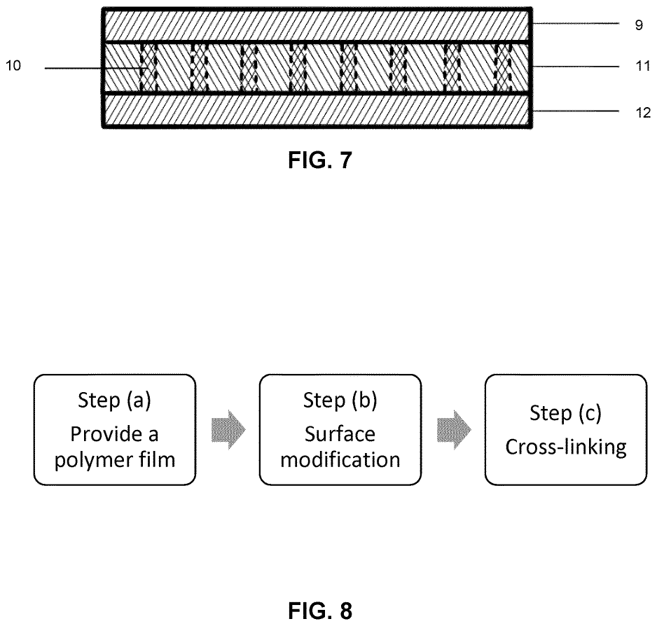

FIG. 7 illustrates a cross-sectional view of a packaging film according to an embodiment of the present disclosure. The embodiment of FIG. 7 shows a packaging film (11). The exterior of the film may be coated with a modifiable OTR controlling gel (12). The packaging film (10) may be a compostable, antimicrobial and micro-perforated packaging film.

FIG. 7 shows an embodiment of a packaging film (11) having an interior food-contact surface, and an antimicrobial agent (9) linked to the interior surface via the chemical link. The interior surface of FIG. 7 may be a surface having a plurality of pores (10), such as a micro-perforated surface. The packaging film may further comprise a hydrogel layer disposed on the surface, and the hydrogel layer may comprise the antimicrobial agent. In an embodiment, the hydrogel layer may be the antimicrobial agent. In another embodiment, the hydrogel layer may be linked to the antimicrobial agent.

A barrier coating on the exterior surface may further adjust or regulate the oxygen transmission rate of the packaging film. A method of preparing the packaging film may comprise regulating the oxygen transmission rate of the packaging film by varying a thickness of the applied barrier coating.

A method of preparing the packaging film may include applying the barrier coating by a controlled deposition technique. The controlled deposition technique may be selected from the group consisting of: Mayer rod coating, doctor blading, spray deposition Langmuir-Blodgett film deposition and slot-die coating. The barrier coating may be chemically cross-linked to form a substantially stable hydrogel-like coating.

In one or more embodiments, the method of preparing the packaging film may include: selecting a thickness of the gel coating to further adjust the oxygen transmission rate; and regulating the oxygen transmission rate of the packaging film by applying the gel coating using the selected thickness.

### Vacuum Maintenance

In one or more embodiments, the packaging film of the present disclosure has an OTR of about or less than about 7,000 cc/m²/day. It will be understood that a target OTR may vary depending upon the application.

In one or more embodiments, the packaging film may be configured to hold vacuum. The packaging film may be configured to hold vacuum such that it may be used in vacuum packaging, such as skin packaging for seafood. The film may be configured to hold vacuum for about 1 day or more, such as about 1 week or more, or about 2 weeks or more.

### Antimicrobial Properties

In one or more embodiments, the compostable film having oxygen transmission properties may be an antimicrobial film, and more particularly an antimicrobial film for packaging of a perishable item. According to an embodiment, the present disclosure provides a packaging film comprising a polymer film having an interior food-contact surface, and an antimicrobial agent chemically linked to the interior surface. The polymer film having an interior food-contact surface may be a compostable, micro-perforated film. According to another embodiment, the present disclosure provides a method of preparing a packaging film, the method comprising: (a) providing a polymer film having an interior food-contact surface; (b) modifying the interior surface by micro-perforation, and additionally by UV, chemical oxidation, plasma or corona treatment; and (c) chemically linking an antimicrobial agent to the modified interior surface. In an embodiment, the packaging film may be used in packaging for a perishable item.

Some examples of known packaging films are as follows. KR101417767B1 teaches antibacterial film for food packaging comprising chitosan and an inorganic antibacterial agent and a method for producing the same. CH713367B1 teaches a method for prolonging the refrigerated storage period of peeled conditioned shrimp by keeping it fresh with antibacterial active material in combination with keeping fresh under a modified atmosphere. US10494493B1 teaches biodegradable composite membranes with antimicrobial properties consisting of nanocellulose fibrils, chitosan, and S-Nitroso-N-acetylpenicillamine (SNAP) for food packaging applications. Other examples may be found in WO2018106191A1, CN110105612A, CN110591300A, KR20190119501A, CN110127769, US20060154894A1, WO2019113520, US2012232191, and US20180340049, though this is not an exhaustive list.

In view of the shortcomings in existing antimicrobial packaging technologies, embodiments of the present disclosure seek to produce customizable packaging film to respond to the development of antimicrobial resistance such that a variety of antimicrobial agents may be incorporated, singly or in combination. This may, for example, increase the suitability of a given packaging film or type of film for an increased number of microbial targets. Additionally, the customization may allow for a targeting of microbes that may be most commonly found in accordance with the package contents.

In an embodiment, an antimicrobial film according to the present disclosure may be fabricated by chemically binding a thin hydrogel layer on the surface of a substrate, for example PBAT, in order to impart antimicrobial properties. The mechanism of action of the film may be to have an antimicrobial surface that is effective upon contact with a perishable item, and not via antimicrobial agents diffusing from the surface into the food item.

The thin hydrogel layer may be composed of IgY antibodies and chitosan.

IgY against Escherichia coli(E. Coli) may be produced by immunizing a chicken with whole deactivated E. Coli bacteria, which results in the production of IgY in the egg yolk. Chitosan may be used since it also has antimicrobial properties, but also provides the matrix component of the hydrogel that anchors IgY to the PBAT surface and swells upon contact with, for example, the surface of the fish fillet.

Using IgY antibodies may allow customization of antimicrobial properties to target specific microbes, for example, bacteria. This ability to specifically target bacteria, and the ability to customize a formulation depending on the most detrimental microbe for a given perishable item may enhance shelf life of that item.

Unlike broad-range antimicrobial agents, IgY may be produced to target resistant bacteria that can build resistance to widely used antibacterial agents. The experiments herein were done using IgY produced against E. Coli.However, IgY against other microbes, such as three of the main spoilage bacteria in fresh salmon, may also be possible.

The antimicrobial agent may be immunoglobulin Y (lgY). IgY may be an IgY against a bacterium, virus, or fungi. IgY may be an IgY against a virus, such as Sars-Cov-2. IgY may be an IgY against a bacterium, such as a spoilage or contamination bacterium. IgY may be an IgY against a bacterium selected from the group consisting of Escherichia coli, Shewanella putrefaciens, Pseudomonas fluorescens, Photobacterium phosphoreum, Listeria monocytogenes, Lactic Acid Bacteria, and Clostridium Botulinum. IgY may be an IgY against Escherichia coli(E. coli). IgY may be an IgY against a virus, such as of the SARS-associated coronavirus such as SARS-COV and SARS-COV-2, influenza A and B, such as type A H1N1, H3N2 or type B victoria and yamagata. IgY may be isolated from a chicken egg yolk. IgY against E. coli may be isolated from a chicken egg yolk produced in a chicken that was immunized with whole deactivated E. coli bacteria. The IgY may be produced by any other suitable manner, such as those well known in the art (see, for example, Refs [1 and 5-7]).

The terms chemically linked, covalently linked, and cross-linked may be used interchangeably. Chemically linked may include any means of linking the antimicrobial agent to the interior surface, such as by covalent bond formation. For example, the antimicrobial agent may be covalently linked to a hydrogel by an amide bond. The hydrogel may be chemically linked to a film surface. The hydrogel itself may be an antimicrobial agent. The hydrogel may be a weak antimicrobial agent. The hydrogel may not be an antimicrobial agent but may be linked to an antimicrobial agent.

The hydrogel layer may comprise one or more polymers. The hydrogel layer may be a natural, naturally-derived, or synthetic polymer. The hydrogel layer may be selected from dextran, cellulose and its derivatives, (e.g. carboxymethyl cellulose, hydroxyethyl cellulose, hydroxypropyl cellulose, methyl cellulose hydroxypropyl methylcellulose, cellulose acetate phthalate), hyaluronic acid, chitosan, gelatin, starch, pectin, alginate, polyacrylamide, poly acrylic acid, poly methyl methacrylate, poly lactic acid, polyvinylpyrrolidone, poly 2-hydroxyethyl methacrylate and combinations thereof.

FIG. 8 is a flowchart illustrating a method of producing a packaging film according to an embodiment of the present disclosure. In an embodiment, the method includes the steps of (a) providing a polymer film having an interior food-contact surface; (b) modifying the interior surface by UV, chemical oxidation plasma or corona treatment; and (c) chemically linking an antimicrobial agent to the modified interior surface. The method may include forming a polymer into the polymer film, prior to step (a).

The method may include extruding a polymer resin into the polymer film by film blowing or film casting. It will be understood that any other suitable means of forming a polymer film may be used, without departing from the scope of the present disclosure. The polymer film may be formed from PBAT, polylactic acid, a polyhydroxyalkanoate, polybutylene succinate, a cellulose-based material, polyglycolic acid, polycaprolactone, polyvinyl alcohol, a carbohydrate-based material, a protein-based material, polyethylene, polypropylene, polyvinyl chloride, polyethylene terephthalate, polystyrene, or combinations thereof. The polymer film may be formed from PBAT.

The polymer film may have a thickness of about 10 μm to about 500 μm. The polymer film may have a thickness of about 80 μm. The polymer film may have a thickness of about 10 μm, about 20 μm, about 30 μm, about 40 μm, about 50 μm, about 60 μm, about 70 μm, about 75 μm, about 80 μm, about 85 μm, about 90 μm, about 100 μm, about 200 μm, about 300 μm, about 400 μm, or about 500 μm. The polymer film may have a thickness of about 20 to about 100 μm, about 30 to about 100 μm, about 40 to about 100 μm, about 50 to about 100 μm, about 60 to about 100 μm, about 70 to about 100 μm, about 80 to about 100 μm, about 90 to about 100 μm, about 100 to about 200 μm, about 200 to about 300 μm, about 300 to about 400 μm, about 400 to about 500 μm, about 250 to about 500 μm, about 100 to about 500 μm, about 70 to about 90 μm, about 80 to about 90 μm, about 70 to about 80 μm, about 75 to about 85 μm, or about 79 to about 81 μm.

The step of modifying the interior surface of the polymer film by UV, plasma or corona treatment (“step (b)”, or “the modifying step”) may be carried out by any suitable procedure or method. Treatment with UV light of a suitable wavelength may be used to modify the interior surface. For example, the modifying step may be done in the presence of UV light of from about 100 to about 400 nm, or about 254 nm and with a power of 1-500,000 milli Watts, or about 15 mW and with an exposure time at about 1-216,000 seconds, or about 60 s. For example, arc discharge, corona discharge, or dielectric barrier discharge may be used. Additionally, atmospheric plasma may be used. The modifying step may be done in a plasma chamber in the presence of oxygen. The modifying step may be done in the plasma chamber at about 5 to about 1000 Watts. The modifying step may be done at about 200 Watts. The modifying step may be done at about 5, about 10, about 20, about 50, about 100, about 150, about 200, about 250, about 300, about 350, about 400, about 450, about 500, about 600, about 700, about 800, about 900, or about 1000 Watts. The modifying step may be done at about 150 to about 250 Watts, about 150 to about 200 Watts, about 200 to about 250 Watts, about 100 to about 300 Watts, about 100 to about 400 Watts, about 100 to about 500 Watts, about 100 to about 1000 Watts, about 500 to about 1000 Watts, about 750 to about 1000 Watts, or about 50 to about 500 Watts. The modifying step may be done at any suitable pressure, such as about 250 mTorr to about 760 mTorr. The modifying step may be done at atmospheric pressure. The modifying step may be done for any suitable amount of time to achieve surface modification of the polymer film. The modifying step may be done for milliseconds to minutes. The modifying step may be done for about 100 milliseconds to about 10 minutes. The modifying step may be done for about 3 minutes. The modifying step may be done for about 1 minute, about 2 minutes, about 4 minutes, or about 5 minutes. The modifying step may be done for less than 1 minute. The modifying step may be done for more than 5 minutes.

The modifying step may include treating the interior surface with a solution after the UV, chemical oxidation plasma or corona treatment. The solution may be any suitable solution to facilitate the surface modification of the polymer film. The solution may comprise a carboxylic acid. Herein, the term “carboxylic acid” may refer to any molecule containing a carboxylic acid or a reactive carboxyl chemical group. For example, the carboxylic acid may be formic acid, acetic acid, propionic acid, butyric acid, valeric acid, caproic acid, enantic acid, caprylic acid, pelargonic acid, capric acid, fumaric acid, malic acid, acrylic acid, citric acid, gluconic acid, itaconic acid, adipic acid, oxalic acid, malonic acid, succinic acid, glutaric acid, pimelic acid, suberic acid, azelaic acid, sebacic acid, keto acids, aspartic acid, glutamic acid, sodium acetate, potassium acetate, ammonium acetate, or vinyl acetate, or combinations thereof. The carboxylic acid may be acetic acid, citric acid, or acrylic acid. The solution may be about 25% acetic acid to about 99% acetic acid in water. The solution may be about 25%, about 30%, about 40%, about 50%, about 60%, about 70%, about 80%, about 90%, about 95%, or about 99% acetic acid in water, or in any suitable solvent. The solution may be glacial acetic acid, or about 100% acetic acid. The modifying step may include washing the interior surface with water after treating the interior surface with the solution. The modifying step may include washing the interior surface with any suitable solvent after treating the interior surface with the solution.

The step of chemically linking an antimicrobial agent to the modified interior surface (“step (c)”, or “the linking step”) may be carried out by any suitable procedure or method. Chemically linking may include covalent linking, crosslinking, or any means of linking the antimicrobial agent to the interior surface. The antimicrobial agent may be linked to the interior surface covalently by an amide bond. The linking step may include crosslinking the antimicrobial agent to the modified surface in the presence of a crosslinking reagent. The crosslinking reagent may be 1-(3-dimethylaminopropyl)-3-ethylcarbodiimidehydrochloride (EDC) and N-hydroxysuccinimide (NHS). The linking step may include treating the modified interior surface with the antimicrobial agent, EDC, and NHS, in an aqueous solution. The linking step may include treating the modified interior surface with chitosan, IgY, EDC, and NHS, in an aqueous solution. The linking step may include treating the modified interior surface with chitosan, IgY, EDC, and NHS, to form a film with a chitosan hydrogel layer disposed on the interior surface, and to form amide bonds between (i) chitosan and the film, (ii) chitosan and IgY, and/or (iii) IgY and the film. The linking step may be done under any suitable conditions to crosslink the antimicrobial agent and the modified interior surface. The linking step may be done at about 20 to about 60° C., such as at about 40° C. The linking step may be done at about room temperature to about 65° C. The linking step may be done for about 100 milliseconds to about 1 hour. The linking step may be done for about 15 minutes, about 30 minutes, about 45 minutes, or about 1 hour. The linking step may be done for more than about 1 hour. The linking step may be done for less than about 15 minutes. The linking step may be done for less than 1 minute, such as less than 1 second.

The method of producing a packaging film may include washing the film to remove unreacted crosslinking reagent and/or unbound antimicrobial agent. The washing may be done with water or any other suitable solvent.

The packaging film as described herein may be customizable to target specific bacteria. The packaging film may have the ability to target bacteria that have developed resistance to other antimicrobial agents. The customizability of the film may allow the film to be used in the packaging of various products.

### EXAMPLES

### Example 1

### Preparation of PBAT Films

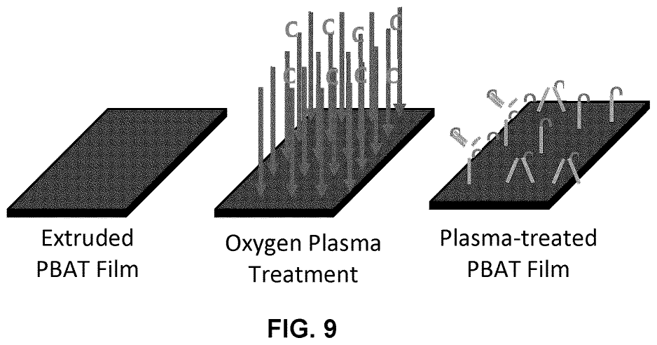

PBAT is a polymer with the chemical structure shown in FIG. 2. Plasma O₂ treatment of the polymer film can be carried out as shown in FIG. 9. FIG. 9 is a schematic diagram of the oxygen plasma treatment of a polymer film to create functional groups on the surface of the film. The functional groups formed on the surface of a PBAT film after oxygen plasma treatment may include carboxyl groups, alcohols, and epoxides. Carboxyl groups can then be crosslinked to an amine using EDC/NHS crosslinkers. For example, ethanolamine can be used as a model amine to test the crosslinking reaction. FTIR can then be used to detect the amide bonds formed.

A series of PBAT samples (Samples 1-7) were prepared using PBAT film that was previously produced by extruding PBAT resin into a sheet 80 μm thick. This may be done by, for example, film blowing or film casting. The samples (S1-S7) were prepared as follows:

### Sample 1 (S1). PBAT Film

S1 was prepared as follows: PBAT film was washed with water. No other treatment of modifications were applied.

### Sample 2 (S2). PBAT+Acetic Acid (AA)

S2 was prepared as follows: PBAT film was placed in glacial acetic acid for 5 minutes and was washed 3 times with water.

### Sample 3 (S3). PBAT+EDC+NHS+ETH Amine

S3 was prepared as follows: PBAT film was immersed in a solution of EDC, NHS, and ethanolamine for 1 hour. It was then washed three times with water.

Sample 4 (S4). Plasma O₂ 180 s at high power PBAT+EDC+NHS+ETH Amine (P-H-EDC)

S4 was prepared as follows: PBAT film was placed in a plasma chamber at 400 Watts and 250 mTorr for 3 minutes. It was then immersed in a solution of EDC, NHS, and ethanolamine for 1 hour. The film was then washed three times with water.

Sample 5 (S5). Plasma O₂ 180 s at medium power PBAT+EDC+NHS+ETH Amine (P-M-EDC)

S5 was prepared in accordance with the methods of S4 using medium power (200 W) instead of high power (400 W).

Sample 6 (S6). Plasma O₂ 180 s at high power immerse in AA then PBAT+EDC+NHS+ETH Amine (P-H-AA-EDC)

S6 was prepared as follows: PBAT film was placed in a plasma chamber at 400 Watts and 250 mTorr for 3 minutes. It was then immersed in glacial acetic acid solution for 5 minutes. The film was then washed 3 times with water, and then placed in a solution of EDC, NHS, and ethanolamine for 1 hour. The film was then washed three times with water.

Sample 7 (S7). Plasma O₂ 180 s at medium power immerse in AA then PBAT+EDC+NHS+ETH Amine (P-M-AA-EDC)

S7 was prepared in accordance with the methods of S6 using medium power (200 W) instead of high power (400 W).

Samples S1-S7 were placed in a vacuum oven 4 hours prior to analysis. The samples were measured with a Bruker Alpha II instrument with a diamond crystal. Spectra were taken from 4000 to 200 cm⁻¹. Resolution was 4 cm⁻¹. 32 scans were performed per sample. Background was automatically removed by the software. The expected peaks for secondary amides are a strong peak (1700-1650 cm⁻¹), a medium peak (1580-1500 cm⁻¹), and a medium peak (3400-3100 cm⁻¹).

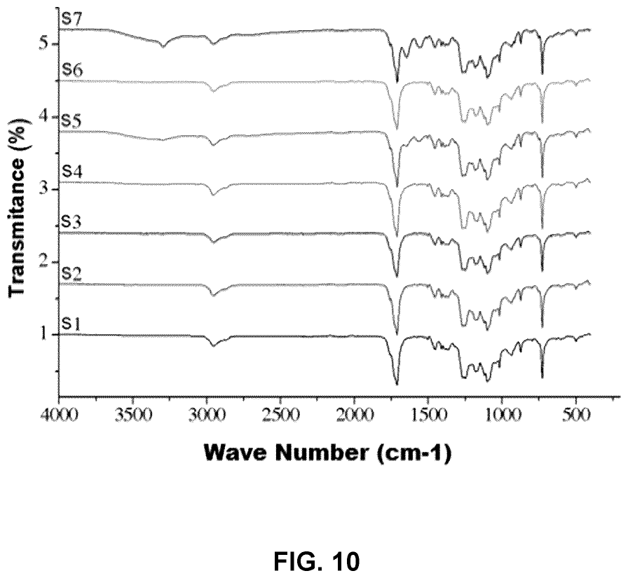

FIG. 10 shows the ATR-FTIR analysis of samples S1-S7. For example, FIG. 10 shows transmittance percentage over wave number (cm⁻¹) in a PBAT Attenuated Total Reflectance-(ATR) FTIR analysis for samples S1-S7. According to FIG. 10, S7 shows the most amide bond formation on the surface, for example, by the presence of peaks at 1560 cm⁻¹, 1645 cm⁻¹, and 3295 cm⁻¹.

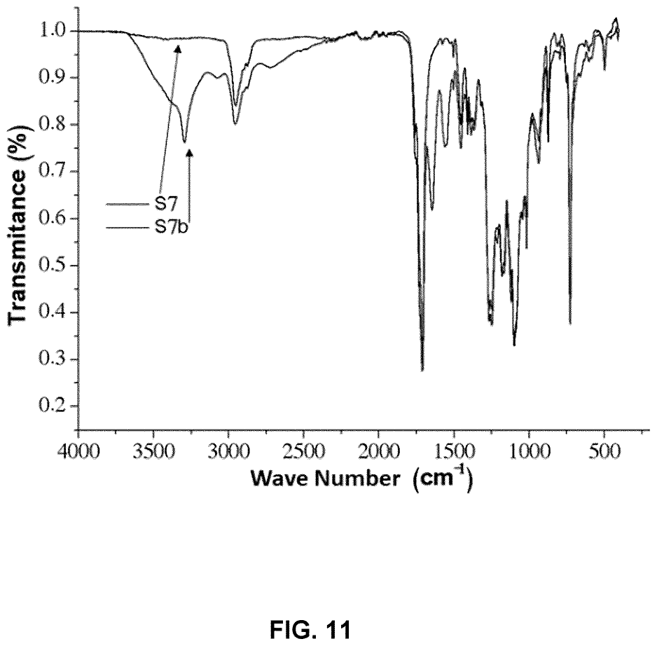

FIG. 11 shows the ATR-FTIR analysis of the treated (interior food contact surface) side of sample S7 (S7) and the exterior, environment-facing surface of the film of sample 7 (S7b). According to FIG. 11, amide bonds were formed only on the surface that was exposed to plasma.

### Example 2

### Preparation of Antibacterial PBAT Film

PBAT film was produced by extruding PBAT resin into a sheet 80 μm thick. This may be done by, for example film blowing or film casting.

The sheet was then cut into the desired sized film samples for experimental or commercial purposes. For example, the sheet may be cut into 1 cm by 1 cm squares.

A notch may be cut or other identification means may be applied to indicate the active surface of the film.

The activation solution is then prepared as follows.

First, 100 mL of a 2.5 mg/mL chitosan solution is prepared in a 0.06 M HCI (stock solution). For experimental purposes, the pH of the desired volume of chitosan solution may be adjusted by dropwise addition of 1 M sodium hydroxide.

Second, a 1-(3-Dimethylaminopropyl)-3-ethylcarbodiimidehydrochloride (EDC) solution is prepared from a stock solution of 20 mg/mL EDC in distilled water.

Third, an N-Hydroxysuccinimide (NHS) solution is prepared from a stock solution of 20 mg/ml NHS in distilled water.

Fourth, an IgY antibody solution is prepared from a 21.5 mg/ml IgY stock solution in Phosphate Buffered Solution. The IgY antibody used in this protocol was prepared by Exalpha Biologics specifically against E. Coli.

The antibacterial PBAT film is then prepared as follows.

The PBAT sample films are placed in a plasma chamber and treated with oxygen at 200 W at 250 mTorr for 3 minutes. The top surface exposed to plasma is considered the treated surface (i.e. active surface or anti-microbial surface), while the bottom surface is not.

Immediately after the plasma treatment, the film samples are immersed in 99% acetic acid for 5 minutes.

The film samples are then washed with distilled water three to four times.

To functionalize the film to render an antibacterial surface, two film samples are placed in a 2 mL low-bind Eppendorf tube. To the Eppendorf tube is added 1.6 mL of 2.5 mg/mL chitosan solution and 18 μl of 0.2 mg/ml IgY solution. Then, 0.2 mL each of freshly prepared EDC and NHS solution are added to the Eppendorf tube to a final concentration of 2 mg/mL each. The film samples are then left to allow the crosslinking reaction to take place for an hour.

The film samples are then washed thoroughly three to four times for ten minutes each with water to ensure the complete removal of unreacted EDC, NHS and any chitosan and IgY unbound to the film sample.

The film samples are then dried at room temperature for 15 minutes and stored in a petri dish until needed.

Prior to use, the film samples are washed three to four times for 10 minutes with water.

### Example 3

Effect of compostable active films on E. coli treated salmon at room temperature (RT) after 24 hours

Chitosan/IgY was grafted onto PBAT film. In situ tests of developed films on salmon fish inoculated with E. coli were then conducted.

### METHODS

3 types of samples were prepared:

1. PBAT film (Control): a PBAT film was prepared according to the method of Example 1, S1.

2. PBAT film treated with plasma (PBAT+Plasma): a PBAT film was prepared by placing the PBAT film in a plasma chamber and treating with oxygen at 200 W at 250 mTorr for 3 minutes.

3. PBAT film grafted with Chitosan and IgY (PBAT+System): a PBAT film was crosslinked with chitosan and IgY according to the method of Example 2.

In order to test the specific antibacterial effect of the film against E. Coli, other bacteria on the fish were first removed through sterilization with a 2,5 % chlorine solution (Calcium Hypochrolite 70% Ca(ClO)₂). Fish samples were then washed three times with water prior to inoculation with E. Coli.

A quantity of 10 μL of 105-106 CFU/ml pre-cultured E. coli was inoculated onto 0.3 g salmon fish samples. The fish samples were placed in petri dishes covered with one of the three types of PBAT film samples (2 pieces—one on top and one on the bottom of the fish sample, 1.5 cm²).

### RESULTS

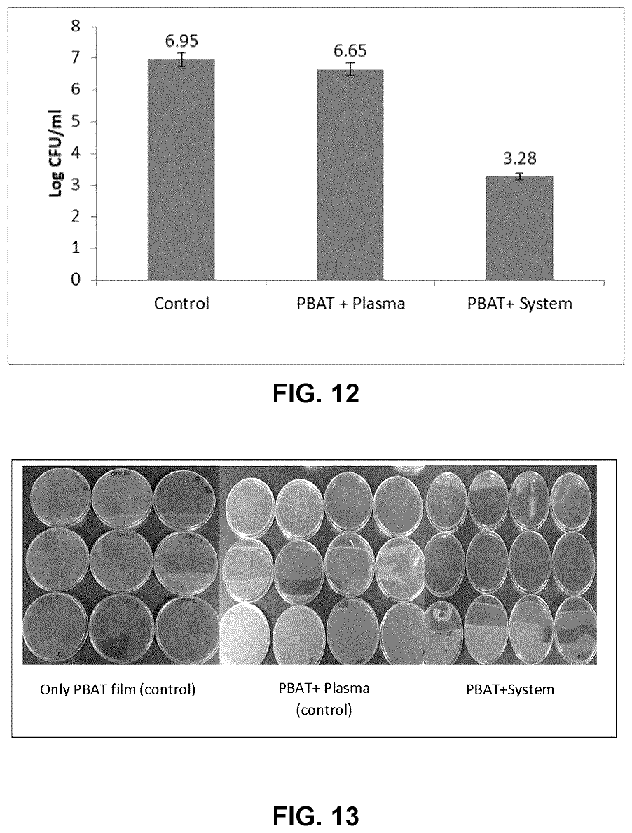

FIG. 12 shows the antibacterial effect of functionalized PBAT films against E. coli treated on salmon fish after 24 hr at room temperature.

FIG. 13 shows photographic images of agar plates of different samples after microbiological analysis showing visual differences between controls and plasma treated film system.

The E. coli growth of control samples reached 6.95 log colony-forming units per milliliter (CFU/mL) after 24 hr of incubation period at room temperature (RT).

For the samples incubated with plasma-treated PBAT films, the bacterial growth was 6.65 log CFU/mL.

For the samples treated with functionalized (i.e. active) films, the growth was 3.28 log CFU/mL, representing a reduction of approximately 3.3 log CFU/mL after 24 hours of incubation, as compared to control samples.

Results from this experiment demonstrate the significant anti-bacterial effect of the active PBAT film against E. Coli. Similarly, this platform technology can include IgY produced against specific spoilage organisms (SSO) involved in spoilage of various fresh foods in order to extend shelf life [9-11]. The ability to customize the active film also allows for targeting resistant bacteria and allows for a broad range protection (i.e. using an antigen common to all gram-negative bacteria to immunize the chicken) or highly specific targeting (i.e. an antigen specific to one bacterial species).

### Example 4

A PBAT film (without coating), such as that of Example 1 or Example 2, was determined to have an oxygen transmission rate (OTR) of 700 cc/m²/day when tested using ASTM D3985 at a thickness of 3 mil (75 microns).

### Example 5

### Effect of Micro-Perforations on OTR

As discussed above, for certain applications it may be desirable to increase the oxygen transmission rate (OTR) of a compostable film, to fabricate a compostable film with a 10,000 cc/m²/day OTR. Such a compostable film may be prepared to comply with FDA regulations for fresh seafood vacuum/skin packaging.

An approach to increase OTR is laser micro-perforation. For use in vacuum packaging and skin packaging fish fillets, the pore size and density will be optimized to hold vacuum for 2 weeks or more. In one or more embodiments, the packaging film may further comprise an antimicrobial formulation, such as those herein described. The impact of such a coating together with optimization of pore size and density may be used to control OTR.

Chemical and physical baseline characterization can be carried out on films of varying thicknesses (e.g. 2 and 2.5 mils), and on films with or without a coating on the surface of the film, such as an antimicrobial agent and/or a hydrogel layer. Light microscopy, SEM and TEM can be used to determine the thickness of the antimicrobial coating on the surface. ATR-FTR can be used to characterize the proper binding of the coating to the surface of the film.

The effect of laser micro-perforation pore sizes (50 μm, 65 μm and 80 μm) can be studied on various films (e.g. on a 2 and 2.5 mil thick film). Furthermore, various pore sizes can be studied at low, medium and high pore densities (pores/cm²) to obtain a desirable OTR. The values for pore densities can be informed by CFD simulations.

Micro-perforated films can be coated with an antimicrobial agent and/or hydrogel layer, such as those exemplified in Examples 1 and 2. The thickness of the antimicrobial coating, the distribution on the surface, and the ability to coat micro-pores can be examined using SEM/TEM. ATR-FTR can be used to characterize the proper binding of the coating to the surface of the film.

In one or more embodiments, the micro-perforated and coated compostable film may have an OTR of 10,000cc/m²/day and may be configured to hold vacuum for up to 2 weeks.

### Example 6

Adjustment of OTR of PBAT Film with Micro-Perforation

To validate that microperforated PBAT may have a barrier coating applied successfully, rolls of PBAT were created by melting commercially available PBAT resin and passed through a blown-film extrusion machine to a final thickness of about 50 μm. Laser perforations with an average size of about 60 μm to about 100 μm were then made into the blown-PBAT film and 3 degrees of micro-perforation density were produced: low (about 100 perforations/m²), medium (about 1000 perforations/m 2), and high (2500 perforations/m²).

Functional chemical groups for covalent bonding on the hydrogel were created on the surface of PBAT via corona-treatment at 1.6 KW for approximately 1 second in ambient air. The functional groups formed on the surface of the PBAT film after corona treatment may include but are not limited to carboxyl groups, ketones, alcohols, aldehydes, and epoxides.

After corona treatment, the barrier coating was prepared using an aqueous mixture of 1% (w/v) carboxy methyl cellulose (CMC) sodium salt, medium viscosity and 20% w/v dried fish gelatin. A crosslinking solution containing 50 mg/mL 1-(3-Dimethylaminopropyl)-3-ethylcarbodiimide hydrochloride (EDC) and 50 mg/ml of N-Hydroxysuccinimide (NHS) was then prepared. After this, the film was removed from the corona treater table and placed on a flat surface. The EDC/NHS solution was mixed into the CMC/gelatin solution and mixed. Then the activated solution was poured onto the corona-treated PBAT film and spread using a Mayer rod to create a homogeneous coating with a thickness of approximately 12.7 μm. Finally, the coated film was then allowed to dry fully. For this coating barrier no initial filler was used to isolate the effect of the pore density in the OTR.

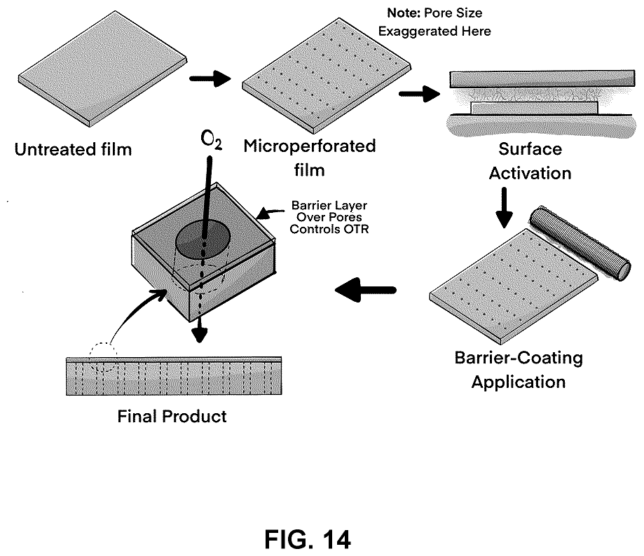

A schematic of this procedure is depicted in FIG. 14.

Additional modified PBAT films were prepared for control purposes. Namely: S8, S9, and S10.

Sample 8 (S8) comprised a PBAT film with no micro-perforations and no further modifications.

Sample 9 (S9) comprised a PBAT film with a medium density of micro-perforations without coating.

Sample 10 (S10) comprised a PBAT film with a medium density of micro-perforations and a oxygen barrier coating of wet thickness of about 12.7 μm applied (as described above) with no filler present.

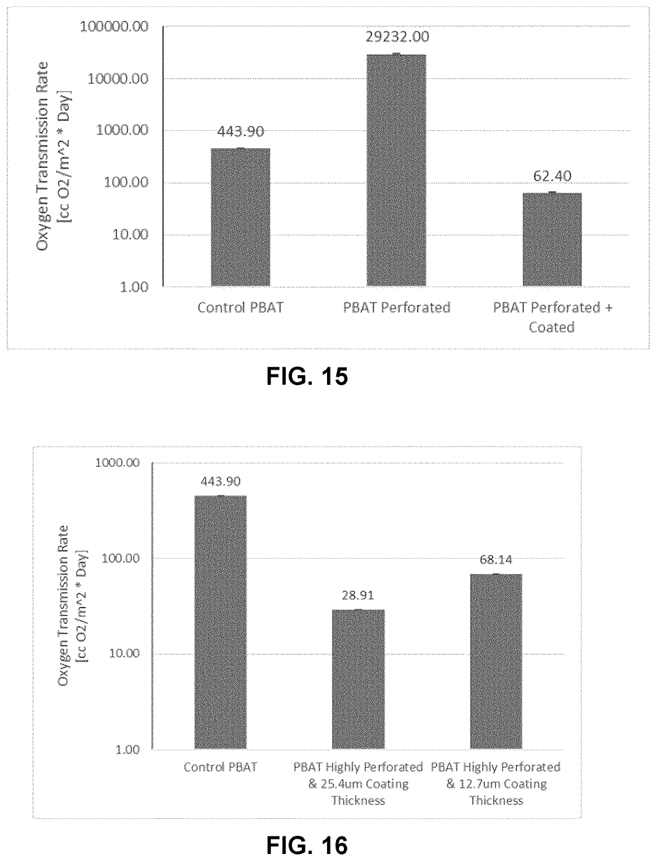

Samples S8-S10 were tested for their OTR using either ASTM F2714-08 or ASTM D-3985. As shown in FIG. 15, the control film S8 shows a lower level of oxygen permeability. Introducing the micro-perforations to the film (S9) created a higher oxygen permeability. Coated film with the micro-perforations (S10) resulted in a lower OTR than either S8 or S9.

### Example 7

### Adjustment of OTR of PBAT Film by Coating Thickness

In another example, additional modified PBAT films were prepared for control purposes. Namely: S11, S12, and S13.

Sample 11 (S11) comprised a PBAT film with no micro-perforations and no further modifications.

Sample 12 (S12) comprised a PBAT film with a high density of micro-perforations and an increased coating thickness of 25.4 μm using a Mayer rod with no filler present.

Sample 13 (S13) comprised a PBAT film with a high density of micro-perforations.

Samples S11-S13 were tested for their OTR using ASTM D-3985. As shown in FIG. 16., the control film $11 shows the oxygen permeability of a control PBAT film. Samples S12 and S13 show how changes in the coating thickness can fine-tune the oxygen permeability, limiting the oxygen that can pass through the pores.

### Example 8

### Adjustment of OTR of PBAT Film by Pore Density

In another example, additional modified PBAT films were prepared for control purposes. Namely, S14, S15, and S16.

Sample 14 (S14) comprised a PBAT film with no micro-perforations and no further modifications.

Sample 15 (S15) comprised a PBAT film with a low density of micro-perforations and no further modifications.

Sample 16 (S16) comprised a PBAT film with a medium density of micro-perforations and no further modifications.

The oxygen permeability of these samples was tested by placing a 7 cm diameter film disk as a membrane between two chambers. Within the 7 cm disk S14 had 1 pore present and S15 had 11 pores present. The first chamber is an oxygen-rich environment supplied with 93% oxygen (remainder largely nitrogen) at a rate of 1 L/min. The second chamber is attached to a gaseous oxygen electrochemical sensor that is initially filled with ambient air. As more oxygen transmits through the membrane, the electrochemical sensor detects and records this change. The higher a film's OTR the quicker the electrochemical sensor will react to the high-concentration stream of oxygen being turned on.

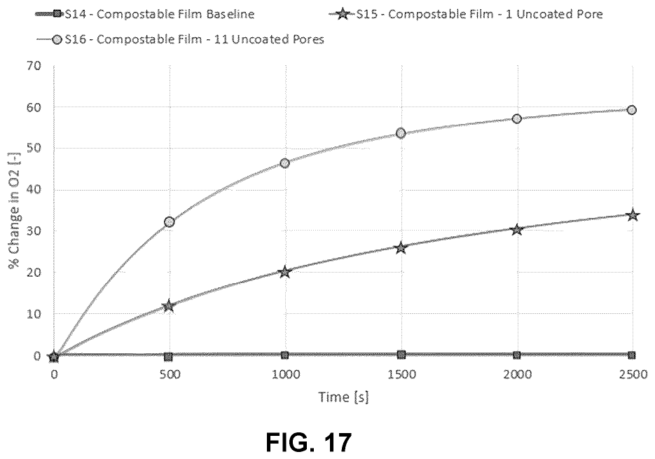

As shown in FIG. 17, the pore density may play a role in adjusting the OTR through the film. The areas of the film where a pore is present will dominate the rate at which oxygen can permeate through the film in comparison to an area with no pore.

### Example 9

### Adjustment of OTR of PBAT Film by Coating Composition

In another example, additional modified PBAT films were prepared for control purposes. Namely, S17, S18, S19 and S20.

Sample 17 (S17) comprised a PBAT film with no micro-perforations and no further modifications.

Sample 18 (S18) comprised PBAT film prepared as in S10 of Example 6, but with 6% (w/v) of DE particles added to the initial CMC/Gelatin solution and shaken vigorously. Additionally, no NHS was added and 0.4 mL of 100 mg/mL EDC was used.

Sample 19 (S19) comprised a PBAT film that was prepared as S18 with the exception that 7% (w/v) of DE particles was added to the initial CMC/Gelatin solution and shaken vigorously.

Sample 20 (S20) comprised a reference OTR as a film with a known OTR of 9212 cc/m²/day determined through ASTM D3985.

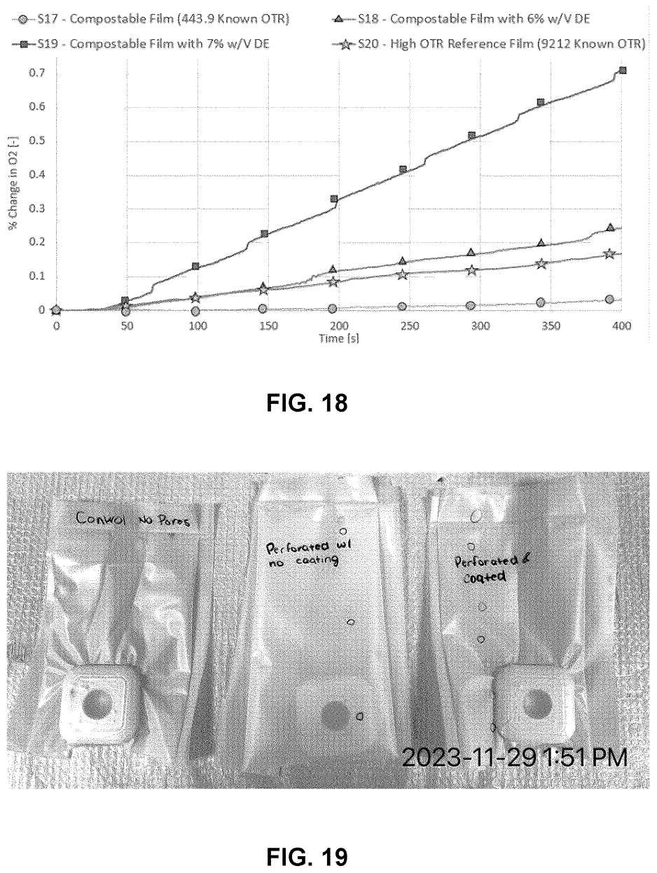

Samples S17, S18, S19, and S20 were prepared then were placed into the same oxygen permeability measuring chamber described in Example 8 one at a time. The results of this experiment are presented in FIG. 18.

Example 10

### Vacuum Maintenance of PBAT Film by Barrier Coating

In another example, additional modified PBAT films were prepared for control purposes. Namely, S21, S22, and S23.

Sample 21 (S21) comprised a PBAT baseline film (no perforations or modifications to the base film).

Sample 22 (S22) comprised a PBAT film that had been perforated. The perforation locations are denoted in the FIG. 19 as small black circles.

Sample 23 (S23) comprised PBAT film that had been perforated and then coated with the same treatment as film S18 in Example 9. Therefore, this is a high-OTR transmitting film (>=10,000 OTR).

A 15 cm×25 cm sheet of PBAT was cut and folded in half lengthwise. Beginning at either edge of the film, fold the edge inwards about 3 cm and heat seal it for about 4 seconds (twice, one adjacent to the next to ensure proper sealing). This step was repeated with the other side of the film; this creates a pouch. A small “puck” was 3D printed with a hole in the center and was placed inside the pouch. The puck was used as a semi-quantitative measurement of the vacuum within the packaging by measuring the distance between the two concave packaging sides. With a proper vacuum, the packaging was concave inwards on the puck hole, whereas if there is no vacuum the packaging was not concave into the hole of the puck.

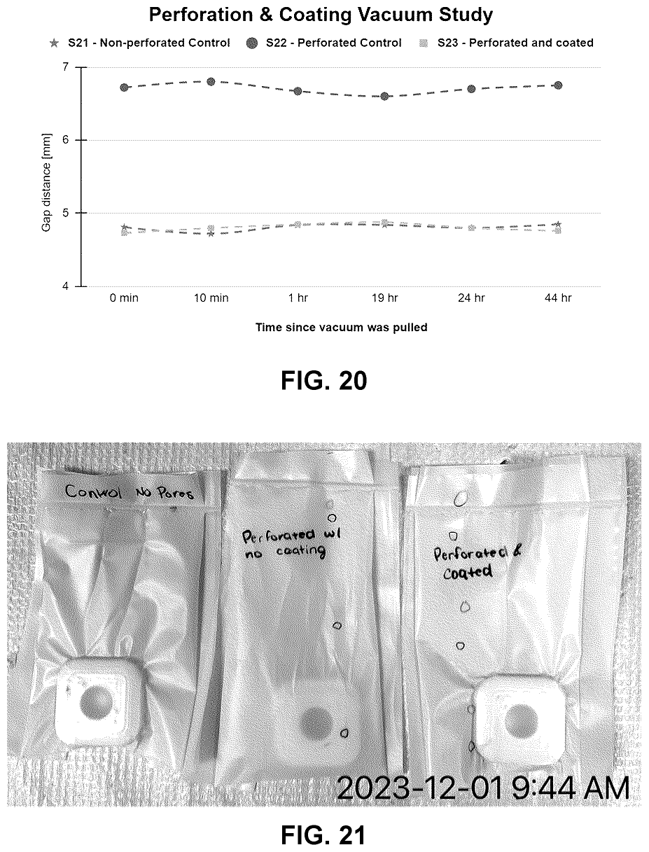

FIG. 19 shows the image of the films immediately after creating the vacuum seals. S22 did not hold vacuum and remained saggy. However, S21 and S23 both maintained vacuum. The gap was also measured at fixed time intervals and this data is presented in FIG. 20. The gap measurement continued for 44 hours and both samples (S21 and S23) held vacuum strongly as shown qualitatively in FIG. 21 and again quantitatively in FIG. 20.

In the preceding description, for purposes of explanation, numerous details are set forth in order to provide a thorough understanding of the embodiments. However, it will be apparent to one skilled in the art that these specific details are not required.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

In addition, the steps and the ordering of the steps of methods described herein are not meant to be limiting. Methods comprising different steps, different number of steps, and/or different ordering of steps are also contemplated.

The above-described embodiments are intended to be examples only. Alterations, modifications and variations can be effected to the particular embodiments by those of skill in the art without departing from the scope, which is defined solely by the claims appended hereto. Further numbered embodiments are outlined below.

### EMBODIMENTS

Embodiment 1. A compostable packaging film comprising: a flexible packaging material having an interior food-contact surface and an exterior environment-facing surface opposite the interior surface, the flexible packaging material defining a plurality of pores fluidly connecting the interior surface and the exterior surface; and a barrier coating covering the exterior surface and covering the plurality of pores on the exterior surface.

Embodiment 2. The film according to Embodiment 1, wherein the pores are micro-pores.

Embodiment 3. The film according to Embodiment 2, wherein the micro-pores are from about 1 to about 250 μm in size, such as about 50 μm, about 65 μm, or about 80 μm.

Embodiment 4. The film according to any one of Embodiments 1 to 3, wherein the plurality of pores are of substantially the same size.

Embodiment 5. The film according to any one of Embodiments 1 to 3, wherein the plurality of pores have varying sizes.

Embodiment 6. The film according to any one of Embodiments 1 to 5, wherein the flexible packaging material defines the plurality of pores with low pore density, medium pore density, or high pore density.

Embodiment 7. The film according to any one of Embodiments 1 to 6, wherein the flexible packaging material defines the plurality of pores with a substantially consistent pore density.

Embodiment 8. The film according to any one of Embodiments 1 to 6, wherein the flexible packaging material defines the plurality of pores with varying pore density.

Embodiment 9. The film according to any one of Embodiments 1 to 8, wherein the flexible packaging material has a thickness of about 1 mil to about 5 mils, such as about 2 mils, 2.5 mils, or 3 mils.

Embodiment 10. The film according to any one of Embodiments 1 to 9, wherein the flexible packaging material has an oxygen transmission rate greater than about 7,000 cc/m²/day, such as about 10,000 cc/m²/day.

Embodiment 11. The film according to any one of Embodiments 1 to 9, wherein the flexible packaging material has an oxygen transmission rate of about or less than about 7,000 cc/m²/day.

Embodiment 12. The film according to any one of Embodiments 1 to 11, wherein the flexible packaging material is configured to hold vacuum.

Embodiment 13. The film according to any one of Embodiments 1 to 12, wherein the flexible packaging material is configured to hold vacuum for about 1 day or more, such as about 1 week or more, or about 2 weeks or more.

Embodiment 14. The film according to any one of Embodiments 1 to 13, further comprising an antimicrobial agent chemically linked to the interior surface.

Embodiment 15. The film according to any one of Embodiments 1 to 14, further comprising a hydrogel layer disposed on the interior surface.

Embodiment 16. The film according to any one of Embodiments 1 to 15, wherein the flexible packaging material comprises a polymer selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof.

Embodiment 17. The film according to embodiment 16, wherein the polymer is PBAT.

Embodiment 18. The film according to Embodiment 1, wherein the barrier coating comprises at least one biopolymer.

Embodiment 19. The film according to any one of Embodiments 1 to 18, wherein the barrier coating covers substantially all of the pores.

Embodiment 20. The film according to any one of Embodiments 1 to 19, wherein the barrier coating is cross-linked to form a substantially stable hydrogel-like coating on the exterior surface.

Embodiment 21. A method of preparing a packaging film, the method comprising:
(a) providing a polymer film having an interior food-contact surface and an exterior environment-facing surface opposite the interior surface;
(b) modifying the polymer film by micro-perforation, to increase an oxygen transmission rate of the packaging film; and
(c) applying a barrier coating to the exterior surface to further adjust the oxygen transmission rate of the packaging film.

Embodiment 22. The method according to Embodiment 21, further comprising:
(d) modifying the interior surface by UV, chemical oxidation, plasma or corona treatment; and
(e) chemically linking an antimicrobial agent to the modified interior surface, wherein steps (d) and (e) are carried out after step (b).

Embodiment 23. The method according to Embodiment 21, further comprising:
(f) modifying the interior surface by UV, chemical oxidation, plasma or corona treatment; and
(g) chemically linking an antimicrobial agent to the modified interior surface, wherein steps are carried out in the order (a), (f), (g), (b), (c).

Embodiment 24. The method according to Embodiment 22, wherein (d) further comprises chemically linking a hydrogel layer to the modified interior surface.

Embodiment 25. The method according to any one of Embodiments 21 to 24, further comprising forming a polymer into the polymer film, prior to step (a).

Embodiment 26. The method according to Embodiment 25, wherein forming the polymer into the polymer film comprises extruding a polymer resin into the polymer film by film blowing or film casting.

Embodiment 27. The method according to any one of Embodiments 21 to 26, wherein the polymer is selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof.

Embodiment 28. The method according to Embodiment 27, wherein the polymer is PBAT.

Embodiment 29. The method according to any one of Embodiments 21 to 28, wherein the polymer film has a thickness of about 1 μm to about 500 μm.

Embodiment 30. The method according to any one of Embodiments 21 to 29, wherein the polymer is a compostable polymer.

Embodiment 31. The method according to any one of Embodiments 21 to 30, further comprising applying a gel coating to the exterior surface to further adjust the oxygen transmission rate of the packaging film.

Embodiment 32. The method according to Embodiment 31, further comprising
selecting a thickness of the gel coating based on a target oxygen transmission rate; and
regulating the oxygen transmission rate of the packaging film by applying the gel coating using the selected thickness.

Embodiment 33. The method according to Embodiment 31 or 32, further comprising:
regulating the oxygen transmission rate of the packaging film by varying a thickness of the applied gel coating.

Embodiment 34. The method according to any one of Embodiments 31 to 33, wherein the gel coating comprises one or more fillers to further adjust the oxygen transmission rate of the packaging film.

Embodiment 35. The method according to Embodiment 34, wherein the one or more fillers is selected from the group consisting of: porous micro-and nanoparticles made of organic and inorganic materials, including but not limited to silicon, amorphous silica, diatomaceous earth, silicon dioxide, aluminum-based, Zeolites, calcium carbonate, kaoilin, alumina trihydrate, calcium sulfate, carbon-based particles, gold, silver, copper, zinc, and their oxides, etc. Biopolymeric particles including but not limited to cellulose-based, chitin, gelatin, chitosan, alginate, polylactic acid, and polyglycolic acid. Synthetic polymeric particles including but not limited to polymethyl methacrylate, polystyrene, polyacrylate, Polytetrafluoroethylene, Poly(vinyl acetate), and Poly(vinyl chloride.

Embodiment 36. The method according to any one of Embodiments 21 to 35 further comprising:
selecting a thickness of the barrier coating based on a target oxygen transmission rate; and
regulating the oxygen transmission rate of the packaging film by applying the barrier coating using the selected thickness.

Embodiment 37. The method according to any one of Embodiments 21 to 36 further comprising:
regulating the oxygen transmission rate of the packaging film by varying a thickness of the applied barrier coating.

Embodiment 38. The method according to any one of Embodiments 21 to 37, wherein the barrier coating is applied by a controlled deposition technique.

Embodiment 39. The method according to Embodiment 38, wherein the controlled deposition technique is selected from the group consisting of: Mayer rod coating, doctor blading, spray deposition, Langmuir-Blodgett film deposition and slot-die coating.

Embodiment 40. The method according to any one of Embodiments 21 to 39, wherein the barrier coating is chemically cross-linked to form a substantially stable hydrogel-like coating.

Embodiment 41. A packaging film prepared according to the method of any one of Embodiments 21 to 40.

Embodiment 42. The packaging film according to Embodiment 41, wherein the packaging film is compostable.

Embodiment 43. Use of the film according to any one of Embodiments 1 to 20, 41 or 42, in packaging for a perishable item.

Embodiment 44. The use according to Embodiment 43, wherein the food contact surface of the film is configured to be in contact with a surface of the perishable item.

Embodiment 45. A method of preparing a packaging film, the method comprising:
(a) providing a polymer film having an interior food-contact surface and an exterior environment-facing surface opposite the interior surface;
(b) modifying the polymer film by micro-perforation, to increase an oxygen transmission rate of the packaging film;
(c) applying a barrier coating to the exterior surface to further adjust the oxygen transmission rate of the packaging film;
(d). modifying the interior surface by UV, chemical oxidation, plasma or corona treatment;
(e) chemically linking an antimicrobial agent to the modified interior surface,
(f) modifying the interior surface by UV, chemical oxidation, plasma or corona treatment; and
(g) chemically linking an antimicrobial agent to the modified interior surface.

### REFERENCES

1. Abbas, A.T., et al., IgY antibodies for the immunoprophylaxis and therapy of respiratory infections. Hum Vaccin Immunother, 2019. 15(1): p. 264-275.
2. Camerini, S., Marcocci, L., Picarazzi, L., lorio, E., Ruspantini, I., Pietrangeli, P., Crescenzi, M., & Franciosa, G. (2019). Type E Botulinμm Neurotoxin-Producing Clostridium butyricum Strains Are Aerotolerant during Vegetative Growth. MSystems, 4(2). https://doi.org/10.1128/msystems.00299-18
3. Centers for Disease Control and Prevention. (2021, Jun. 1). About Botulism. Retrieved Sep. 20, 2022, from http://www.cdc.gov/botulism/general.html
4. Gilbert, S., Lake, R., Hudson, A., & Cressey, P. (2006). Risk Profile: Clostridium botulinum in ready-to-eat smoked seafood in sealed packaging. A Crown of Research Institute. www.esr.cri.nz
5. Hu, B., et al., The preparation and antibacterial effect of egg yolk immunoglobulin (IgY) against the outer membrane proteins of Vibrio parahaemolyticus. J Sci Food Agric, 2019. 99(5): p. 2565-2571.
6. Kollberg, H., Avian antibodies (IgY) to fight antibiotic resistance. Clinical Microbiology: Open Access, 2015. 4(2).
7. Sui, J., L. Cao, and H. Lin, Antibacterial activity of egg yolk antibody (IgY) against Listeria monocytogenes and preliminary evaluation of its potential for food preservation. J Sci Food Agric, 2011. 91(11): p. 1946-50.
8. Lee, E. N., et al., In vitro studies of chicken egg yolk antibody (IgY) against Salmonella enteritidis and Salmonella typhimurium. Poult Sci, 2002. 81(5): p. 632-41.
9. Boziaris, I. S. and F. F. Parlapani, Specific spoilage organisms (SSOs) in fish, in The microbiological quality of food. 2017, Elsevier. p. 61-98.
10. Nychas, G. J., et al., Meat spoilage during distribution. Meat Sci, 2008. 78(1-2): p. 77-89.
11. Wang, G. Y., et al., Evaluation of the spoilage potential of bacteria isolated from chilled chicken in vitro and in situ. Food Microbiol, 2017. 63: p. 139-146.

What is claimed is:

1. A compostable packaging film comprising:
a flexible packaging material having an interior food-contact surface and an exterior environment-facing surface opposite the interior surface,
the flexible packaging material defining a plurality of pores fluidly connecting the interior surface and the exterior surface; and
a barrier coating covering the exterior surface and covering the plurality of pores on the exterior surface.

2. The film according to claim 1, wherein the pores are micro-pores.

3. The film according to claim 2, wherein the micro-pores are from about 1 to about 250 μm in size, such as about 50 μm, about 65 μm, or about 80 μm.

4. The film according to any one of claims 1 to 3, wherein the plurality of pores are of substantially the same size.

5. The film according to any one of claims 1 to 3, wherein the plurality of pores have varying sizes.

6. The film according to any one of claims 1 to 5, wherein the flexible packaging material defines the plurality of pores with low pore density, medium pore density, or high pore density.

7. The film according to any one of claims 1 to 6, wherein the flexible packaging material defines the plurality of pores with a substantially consistent pore density.

8. The film according to any one of claims 1 to 6, wherein the flexible packaging material defines the plurality of pores with varying pore density.

9. The film according to any one of claims 1 to 8, wherein the flexible packaging material has a thickness of about 1 mil to about 5 mils, such as about 2 mils, 2.5 mils, or 3 mils.

10. The film according to any one of claims 1 to 9, wherein the flexible packaging material has an oxygen transmission rate greater than about 7,000 cc/m²/day, such as about 10,000 cc/m²/day.

11. The film according to any one of claims 1 to 9, wherein the flexible packaging material has an oxygen transmission rate of about or less than about 7,000 cc/m²/day.

12. The film according to any one of claims 1 to 11, wherein the flexible packaging material is configured to hold vacuum.

13. The film according to any one of claims 1 to 12, wherein the flexible packaging material is configured to hold vacuum for about 1 day or more, such as about 1 week or more, or about 2 weeks or more.

14. The film according to any one of claims 1 to 13, further comprising an antimicrobial agent chemically linked to the interior surface.

15. The film according to any one of claims 1 to 14, further comprising a hydrogel layer disposed on the interior surface.

16. The film according to any one of claims 1 to 15, wherein the flexible packaging material comprises a polymer selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof.

17. The film according to claim 16, wherein the polymer is PBAT.

18. The film according to claim 1, wherein the barrier coating comprises at least one biopolymer.

19. The film according to any one of claims 1 to 18, wherein the barrier coating covers substantially all of the pores.

20. The film according to any one of claims 1 to 19, wherein the barrier coating is cross-linked to form a substantially stable hydrogel-like coating on the exterior surface.

21. A method of preparing a packaging film, the method comprising:
(a) providing a polymer film having an interior food-contact surface and an exterior environment-facing surface opposite the interior surface;
(b) modifying the polymer film by micro-perforation, to increase an oxygen transmission rate of the packaging film; and
(c) applying a barrier coating to the exterior surface to further adjust the oxygen transmission rate of the packaging film.

22. The method according to claim 21, further comprising:
(d) modifying the interior surface by UV, chemical oxidation, plasma or corona treatment; and
(e) chemically linking an antimicrobial agent to the modified interior surface, wherein steps (d) and (e) are carried out after step (b).

23. The method according to claim 21, further comprising:
(f) modifying the interior surface by UV, chemical oxidation, plasma or corona treatment; and
(g) chemically linking an antimicrobial agent to the modified interior surface, wherein steps are carried out in the order (a), (f), (g), (b), (c).

24. The method according to claim 22, wherein (d) further comprises chemically linking a hydrogel layer to the modified interior surface.

25. The method according to any one of claims 21 to 24, further comprising forming a polymer into the polymer film, prior to step (a).

26. The method according to claim 25, wherein forming the polymer into the polymer film comprises extruding a polymer resin into the polymer film by film blowing or film casting.

27. The method according to any one of claims 21 to 26, wherein the polymer is selected from the group consisting of polybutylene adipate terephthalate (PBAT), polylactic acid, polyhydroxyalkanoates, polybutylene succinate, cellulose-based materials, polyglycolic acid, polycaprolactone, polyvinyl alcohol, carbohydrate-based materials, protein-based materials, polyethylene, polypropylene, polyvinyl chloride, polyethylene terephthalate, polystyrene, and combinations thereof.

28. The method according to claim 27, wherein the polymer is PBAT.

29. The method according to any one of claims 21 to 28, wherein the polymer film has a thickness of about 1 μm to about 500 μm.

30. The method according to any one of claims 21 to 29, wherein the polymer is a compostable polymer.

31. The method according to any one of claims 21 to 30, further comprising applying a gel coating to the exterior surface to further adjust the oxygen transmission rate of the packaging film.

32. The method according to claim 31, further comprising
selecting a thickness of the gel coating based on a target oxygen transmission rate; and
regulating the oxygen transmission rate of the packaging film by applying the gel coating using the selected thickness.

33. The method according to claim 31 or 32, further comprising: regulating the oxygen transmission rate of the packaging film by varying a thickness of the applied gel coating.

34. The method according to any one of claims 31 to 33, wherein the gel coating comprises one or more fillers to further adjust the oxygen transmission rate of the packaging film.

35. The method according to claim 34, wherein the one or more fillers is selected from the group consisting of: porous micro-and nanoparticles made of organic and inorganic materials, including but not limited to silicon, amorphous silica, diatomaceous earth, silicon dioxide, aluminum-based, Zeolites, calcium carbonate, kaoilin, alumina trihydrate, calcium sulfate, carbon-based particles, gold, silver, copper, zinc, and their oxides, etc. Biopolymeric particles including but not limited to cellulose-based, chitin, gelatin, chitosan, alginate, polylactic acid, and polyglycolic acid. Synthetic polymeric particles including but not limited to polymethyl methacrylate, polystyrene, polyacrylate, Polytetrafluoroethylene, Poly(vinyl acetate), and Poly(vinyl chloride).

36. The method according to any one of claims 21 to 35 further comprising:
selecting a thickness of the barrier coating based on a target oxygen transmission rate; and
regulating the oxygen transmission rate of the packaging film by applying the barrier coating using the selected thickness.

37. The method according to any one of claims 21 to 36 further comprising:
regulating the oxygen transmission rate of the packaging film by varying a thickness of the applied barrier coating.

38. The method according to any one of claims 21 to 37, wherein the barrier coating is applied by a controlled deposition technique.

39. The method according to claim 38, wherein the controlled deposition technique is selected from the group consisting of: Mayer rod coating, doctor blading, spray deposition, Langmuir-Blodgett film deposition and slot-die coating.

40. The method according to any one of claims 21 to 39, wherein the barrier coating is chemically cross-linked to form a substantially stable hydrogel-like coating.

41. A packaging film prepared according to the method of any one of claims 21 to 40.

42. The packaging film according to claim 41, wherein the packaging film is compostable.

43. Use of the film according to any one of claims 1 to 20, 41 or 42, in packaging for a perishable item.

44. The use according to claim 43, wherein the food contact surface of the film is configured to be in contact with a surface of the perishable item.

45. A method of preparing a packaging film, the method comprising:
(a) providing a polymer film having an interior food-contact surface and an exterior environment-facing surface opposite the interior surface;
(b) modifying the polymer film by micro-perforation, to increase an oxygen transmission rate of the packaging film;
(c) applying a barrier coating to the exterior surface to further adjust the oxygen transmission rate of the packaging film;
(d) modifying the interior surface by UV, chemical oxidation, plasma or corona treatment;
(e) chemically linking an antimicrobial agent to the modified interior surface, (f) modifying the interior surface by UV, chemical oxidation, plasma or corona treatment; and
(g) chemically linking an antimicrobial agent to the modified interior surface.
